(19) United States
(12) Patent Application Publication
(10) Pub. No.: US 2024/0266076 A1
(43) Pub. Date: Aug. 8, 2024

(54) ANEUTRONIC FUSION PLASMA REACTOR AND ELECTRIC POWER GENERATOR

(71) Applicants: Ken E. Kopp, Spokane Valley, WA (US); Ryan S. Wood, Broomfield, CO (US)

(72) Inventors: Ken E. Kopp, Spokane Valley, WA (US); Ryan S. Wood, Broomfield, CO (US)

(21) Appl. No.: 18/595,585

(22) Filed: Mar. 5, 2024

Related U.S. Application Data
(62) Division of application No. 17/518,120, filed on Nov. 3, 2021.
(60) Provisional application No. 63/204,995, filed on Nov. 9, 2020.

(51) Int. Cl. G21B 1/11; G21B 1/05

(52) U.S. Cl. CPC G21B 1/11; G21B 1/05

(57) ABSTRACT

A method of prompting fusion and harvesting energy therefrom is disclosed. The method includes using lithium and ammonia to create a solvated electron fuel source. An alpha particle or proton source is provided in a reaction site in a chamber where the fuel source is present, thereby prompting fusion events in the reaction site. Energy is then harvested from the fusion events.

### CROSS-REFERENCE TO RELATED APPLICATION

This application is a divisional application of U.S. Non-Provisional patent application Ser. No. 17/518,120, titled “ANEUTRONIC FUSION PLASMA REACTOR AND ELECTRIC POWER GENERATOR”, filed on Nov. 3, 2021, which claims the benefit of priority of U.S. Provisional Patent Application No. 63/204,995, titled “ANEUTRONIC FUSION PLASMA REACTOR AND ELECTRIC POWER GENERATOR,” filed on Nov. 9, 2020, the entire contents of which are hereby incorporated herein by reference.

### TECHNICAL FIELD

The present disclosure relates to the field of thermonuclear fusion plasma and more specifically, aneutronic fusion and apparatus for converting the energy from lithium fusion products directly into electricity.

### BACKGROUND

Aneutronic fusion has been contemplated as the only type of fusion that may one day effectively be, at the same time, clean, safe, and environmentally friendly while providing power to satisfy world energy needs into the future. Aneutronic fusion, unlike fossil fuels and currently available nuclear fission-based power production, should produce no greenhouse gases, no neutron emission, no radioactive waste, no thermal waste, and require no large land areas. Aneutronic fusion, unlike solar and wind power, should not be subject to interruptions by weather or time of day. Unlike conventional current fusion power reactors, aneutronic fusion should be easy to shut down, with no meltdowns, and no proliferation, while delivering a peaceful and prosperous future to Earth.

Several types of aneutronic fusion have been proposed. The most prevalent concept utilizes a mixture of hydrogen and boron. At extremely high temperatures—billions of degrees—hydrogen nuclei (protons) fuse with boron-11 nuclei to form a carbon nucleus very briefly. But the carbon nucleus has too much energy to stay together, so in an instant it breaks up into three helium nuclei and releases energy.

Naturally, achieving billions of degrees is an engineering challenge and consumes massive amounts of energy, typically through lasers. For example, at Ecole Polytechnique in Palaiseau, in France, they fused protons and boron-11 nuclei using a laser-accelerated proton beam and high-intensity laser pulse.

The difficulty of a fusion reaction is characterized by the ignition barrier, the energy required for the nuclei to overcome their mutual Coulomb repulsion. Prior approaches to overcoming the Coulomb barrier have relied on accelerators or laser arrays of great size, requiring large and complex research facilities, the ongoing funding for which requires governmental or large industry funding. While a feasible approach to triggering fusion is sought among mammoth scale devices, particle emissions from some available radioisotopes are overlooked as possible modes of fusion ignition. No known device is both manageable on a small scale and effective in harnessing nuclear fusion-based energy until this disclosure.

There is a rich body of scientific literature around all the elements of this disclosure—Light Element Electric Fusion (LEEF) reactor except one—the fusion principle itself. This is likely why this fusion breakthrough has been missed by mainstream science or possibly classified and hidden from the white scientific world.

The scientific paper trail starts with a famous experiment of Cockroft and Walton 1932, at that time called “the first artificial nuclear disintegration”. They bombarded 7Li with a proton and obtained the unstable 8Be which disintegrated into two alpha-particles. The energy gain in this decay (17.3 MeV is comparable to the energy obtained from a D-T fusion (17.6 MeV). The decay of 8Be delivers the energy as a-particle kinetic energy.

It is this reaction that spurs further research papers, one that stands out that clearly supports our approach—capillary fusion a low energy fusion experiment invented by Lochte-Holtgreven₁. This specific experiment is described as: “A thin glass tube filled with e.g. (lithium solved in heavy ammonia) is subjected to current pulses from a capacitor bank charged to 150-200 kV. After 50-200 ns a drop in the current occurs due to longitudinal disintegration of the solution. During this drop, or current pause, a burst of neutrons is produced for the heavy ammonia. If light ammonia is used no neutrons are produced. The energy supplied in these experiments is about 500J, sufficient to heat the capillary uniformly to about 5000K, and probably less, as ionization energy is not included in the calculation. Thus, the neutrons cannot be produced by thermonuclear reactions; rather acceleration processes seem to be the candidate.”

Furthermore, in a 1987 scientific paper, Lochte-Holtgreven^{2,3} have shown in their research that nuclear fusion reactions of Li—NH₃ and LiND₃ fusion reactions are not thermonuclear, but a hybrid character, i.e., the plasma is not heated to a sufficient temperature for fusion, but electric fields complete the fusion reaction. After the heating the plasma it expands turbulently. During this time, electrical fields post-accelerate the Li and proton nuclei leading to the formation of the unstable 8Be followed by alpha-decay. These fusion reactions occur frequently and are observed during a time much longer than one cycle.

Lochte-Holtgreven experiments clearly show a capillary fusion neutron flux with LiND₃ and in the Li—NH₃ case no neutron production, hence the supporting evidence for aneutronic fusion with this Li proton fuel.

Key to the LEEF breakthrough is a dramatic reduction of the coulomb barrier. In a 2012 paper by Cruz⁴ et al, he concludes that there is no debate that “^{6,7}Li+proton reactions are greatly enhanced when the reactions occur in a metal environment. The mechanism of the enhancement is not fully understood, even though it is well established that it is due to the quasi-free valence electrons of the metal.”

Several researchers⁵ have looked at the idea of electron screening or Debye screening as a mechanism to enhance fusion and lower the Coulomb barrier. For example, “Feng estimates that electron screening based on the assumed dielectric constant can reduce the deuteron distance by as much as 40%—which would then correspond to an enhanced fusion rate of about 10⁻⁴⁰/s (enhancement of about 25-30 orders of magnitude).

Benedek and Bortignon in a 1989 paper discuss some of the possible electronic mechanisms which may provide a sizeable reduction of the Coulomb repulsion between deuterium nuclei adsorbed into metals necessary to explain the reported fusion rates at room temperature.⁶

As further background, in astrophysics it is generally accepted that in the sun exists a zone of the so called “lithium-burning”. This zone is situated in the outer zones of the sun, just below the zone of general (hydrogen) turbulence i.e., about 30,000 km below the surface. There, the temperature is 2.4-106K or 206 eV only. The temperature obtained with body of research in exploding wires is surprisingly near to this value.

Contrary to previous research with exploding wires it is wrong to believe that achieving thermonuclear fusion in the explosion of wires is accomplished by feeding in as much energy as possible in a short time. Instead, it is necessary to produce electrical fields for as long as possible at moderate temperatures and the turbulence of the explosion should be made as strong as possible. This is what the LEEF reactor does with magnetic field compression, physical pressure of plasma reactants and electrical arcing through the plasma fuel.

The standard of fusion system performance is the Lawson Criterion. The Lawson criterion is a figure of merit used in nuclear fusion research. It compares the rate of energy being generated by fusion reactions within the fusion fuel to the rate of energy losses to the environment. The criterion consists of three basic elements: density, temperature, and time. These elements are used to calculate a value known as the “Triple Product.”

LEEF Triple Product is favorable for the follow reasons:

EFS's LEEF fuel operates in a supercritical fluid state with a density order of magnitude higher than any other known approach. LEEF densities are literally off the chart used to document the plethora other approaches.

Ion temperatures orders of magnitude higher and measured in MEV as opposed to KEV seen in other approaches result in significant chain reactions during every fusion cycle. Again, LEEF energies are literally off the chart.

In other approaches stability of magnetic confinement is the primary driver of the confinement & Fusion burn time. This has been a failure point for other approaches. The LEEF process is cyclical and fusion EMF energy is extracted every cycle via magnetic induction at very high efficiencies exceeding 90% as compared to the ˜30% seen in “heat” based extraction used in other approaches. Our induction field by nature is not a steady state field nor should it be lest we suffer the same issues plaguing other programs.

In a preignition state our fuel exhibits a modified coulomb barrier by orders of magnitude through a phenomenon known as electron screening.

The Lawson criterion is fulfilled because of the super critical, extremely dense solvated electron lithium ammonia liquid fuel that is flashed to a plasma via electrical discharge.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

According to at least one embodiment, a method of prompting fusion and harvesting energy therefrom is disclosed. The method includes using lithium and ammonia to create a solvated electron fuel source. An alpha particle or proton source is provided in a reaction site in a chamber where the fuel source is present, thereby prompting fusion events in the reaction site. Energy is then harvested from the fusion events.

According to at least another embodiment, a device includes: a chamber; a magnetic confinement coil surrounding at least a portion of the chamber; a first electrode extending into the chamber; and a second electrode extending into the chamber and spaced from the first electrode defining a gap therebetween; wherein at least one of the first electrode and second electrode includes at least one radioisotope emitting ionizing radiation into the gap.

In at least one example, the first electrode includes a tapered tip; and the second electrode includes a tapered tip.

The first electrode may include a first electrode rod in an array of multiple first electrode rods, each extending toward the gap; and the second electrode may include a second electrode rod in an array of multiple second electrode rods, each extending toward the gap opposite the first electrode rods.

Each first electrode rod may include a tapered tip; and each second electrode rod may include a tapered tip. The tips don't have to be tapered to work.

The device may include a first base and a second base spaced from the first base, with the first electrode rods mounted on the first base; and the second electrode rods mounted on the second base.

In at least one example: the first electrode rods extend from the first base in a first direction; the second electrode rods extend from the second base in a second direction opposite the first direction; and the device further includes: a third base spaced from the second base such that the second base is positioned between the first base and third base; multiple third electrode rods mounted on the third base and extending toward the second base in the second direction; and fourth electrode rods mounted on the second base and extending toward the third base in the second direction.

A first electrode terminus may extend into a reservoir area defined by the chamber, the electrode terminus in electrical communication with a power supply for vaporizing liquid accumulated in the reservoir area.

A second electrode terminus may extend into the reservoir area spaced from the first electrode terminus for vaporizing liquid accumulated in the reservoir area.

A mixture comprising at least lithium and ammonia (NH3) in a stable molar concentration may be in the reservoir area prior to vaporization,

The lithium may include at least one of Li-7 and Li-6 or a combination.

In use of the device, a mixture including at least lithium may be titrated directly into the gap.

The chamber may be cylindrical, circular, spherical, toroidal or of twisted geometry.

The chamber may include stainless steel, ceramic or other metal that will contain pressures and temperatures within the chamber.

The chamber may be resistant to chemical and plasma attack.

The magnetic confinement coil may include an electromagnet consisting of wire, or plates of a single or multiple gauges or other electrically conductive material creating helical coil or coils that serve as both an inductor and electromagnet.

The device may include a pressure relief valve, a pressure measuring device, a temperature measuring device, and a cooling device, either internally within the case or externally around the coils.

The device may include radiation protection and attenuation.

The chamber, in use, may be filled with at least one inert gas.

The inert gas may include at least one of helium and argon.

The device may include a laser emanating a beam into the gap.

The above summary is to be understood as cumulative and inclusive. The above-described embodiments and features are combined in various combinations in whole or in part in one or more other embodiments.

### BRIEF DESCRIPTION OF THE DRAWINGS

The previous summary and the following detailed descriptions are to be read in view of the drawings, which illustrate exemplary embodiments and features as briefly described below. The summary and detailed descriptions, however, are not limited to only those embodiments and features explicitly illustrated.

FIG. 1A is a plot that shows the fusion probability vs. proton energy given our Debye electron screening with our unique lithium ammonia fuel at various molar saturation concentrations. This data is from rigorous simulation software from a 3rd party.

FIG. 1B is a standard plot showing fusion reactivity for proton Li-7 reactions vs. temperature. Similar plots for other common fusion reactions are widely disclosed in the open literature.

FIG. 1C is a fusion simulation plot the first 300 nanoseconds of reactions vs simulated alpha energy. Alpha energy is supplied via the apparatus or integrated into the fuel mixture.

FIG. 1D is a plot of fusion temperature vs time, showing the ignition temperature at approximately 50 keV at about 50 nanoseconds.

FIG. 1E is a plot that shows fusion multiplication or chaining of 2.4 times in the first 300 nanoseconds with our alpha population.

FIG. 1F plots cross section versus incident energy for a number of lithium-based reactions demonstrating fusion-event thresholds below ignition energies made available by embodiments of the invention.

FIG. 2 depicts, overall, the exterior and mechanical features of a reactor device according to at least one embodiment.

FIG. 3 is a cross-sectional view of the device from another perspective, with a forward wall section of the device of FIG. 2 transparent for viewing of the interior.

FIG. 4 is an enlarged view of the reaction area between opposing radioisotope doped electrode arrays in the device of FIG. 2.

FIG. 5 is a perspective view of either electrode array of FIG. 4.

FIG. 6 is a longitudinal view of the electrode array of FIG. 5.

FIG. 7 in an enlarged view of a lowest portion of the illustration of FIG. 3.

FIG. 8 is an electrical schematic showing a buck-boost power supply according to at least one embodiment.

FIG. 9 is a section of a nuclide chart showing reactions chains by which the device of FIG. 1F, and other embodiments, produce useful energy.

FIG. 10 shows a multi-plasma reactor device having a column of electrode arrays, some of which are bi-directional.

FIG. 11 is an enlarged view of a portion of the illustration of FIG. 10.

FIG. 12 is cross-section view of a reactor device, according to yet another embodiment, by which energy is harvest by heat exchange.

FIG. 13 is an enlarged perspective view of portion of the device of FIG. 12.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a,” “an,” and “the” refer to “one or more” when used in the subject specification, including the claims. Unless indicated to the contrary, the numerical parameters set forth in the instant specification and attached claims are approximations that can vary depending upon the desired properties sought to be obtained within the scope of these descriptions.

Systems and processes for fusion as described here are novel and advantageous over prior developments. Aneutronic fusion is achieved: in some embodiment's lithium+proton reactions produce helium+energy, which is converted directly to useable electricity. This revolutionary energy technology, referenced in some of the below descriptions as inventive Light Element Electric Fusion (LEEF), does not emit dangerous radiation. An easier and safer way to generate fusion chain reactions is provided using a cyclical process that cycles into and out of fusion in a plasma with electrical arcing, a magnetic induction field, and pressure confinement. An electrical arc passes through a dense plasma fuel, with pressure confinement. In short, a fusion-plasma “transformer” is provided. A unique fuel is used, and a super dense plasma is created ten orders of magnitude denser than historically failed approaches.

Lithium-proton fusion reactions are preferred for generating virtually no neutrons (thereby supporting aneutronic fusion) or radiation, and have strong energy outputs. A proton is a hydrogen atom stripped of its electron; lithium (Li) is a light, non-radioactive element that is used in lithium-ion batteries and many other industrial applications. Hydrogen-lithium represents a clean, and abundant fusion fuel cycle making it the ideal fuel source for a commercial fusion solution.

A standard for assessing real or theoretical performance of a fusion system is known as the Lawson Criterion. This figure of merit used in nuclear fusion research compares the rate of fusion-reaction generated energy within the fusion fuel to the rate of energy losses to the environment. The criterion utilizes three basic elements: density, temperature, and time. These elements are used to calculate a value known as the “Triple Product.”

The inventive LEEF triple product is favorable for many reasons. For example, the inventive LEEF fuel operates in a supercritical fluid state with a density orders of magnitude higher than any other known approach. The inventive LEEF densities are literally off the charts used to document the plethora other approaches. Ion temperatures orders of magnitude higher and measured in MeV, as opposed to keV seen in other approaches due to the alpha emitting sources, mechanical or blended fuel components such as thorium hydride within the reactor, result in significant chain reactions during every fusion cycle.

The quantum effects in the LEEF reactions it has occurred to the inventors that there is an effect that will contribute or may even dominate the fusion reactions. The LEEF concept produces a great deal of relativistic electrons. These electrons possess sufficient energy to interact with the internal structure of the Li-NH3-e clusters, thus altering the internal charge of the cluster, contributing to the negative charge-well in the cluster interior. This may simply collapse the NH3 shell into the lithium in a sort of molecular fusion of the electron and cluster resulting in sufficient masking to allow Li+p−2a at very low energies. If one assigns multiple negative charges to a set of reactants compressed in a molecular shell of 2-3 Angstroms which is the size of an atom, we have effectively created a long-lived pseudo atom of a sort, a lithium in a proton shell with a radius of 1-1.5 Angstroms with multiple negative charges. Further, this would account for the fusion effects only being seen in the plasma state as-well-as the broad x-ray emissions observed. Rather than a simple loss mechanism the bremsstrahlung radiation which may correlate directly to the Coulomb barrier reduction.

One of the key breakthroughs in this disclosure and apparatus is the fusion fuel. An electrically conductive mixture of lithium and ammonia which forms solvated electrons.⁷

Solvated electrons are a function of the Li concentration. The solvation shell consists of 4 NH3 surrounding each Li cation and the cleaved electron(s) forming clusters with charge potential wells of 2-3 angstroms in size and multiple negative charges, so the 20% Li concentration will be maximum electrical conductivity. Furthermore, the electrons carrying current exhibit quantum tunneling to clusters not adjacent and perhaps 3-4 shells distant. This non-metallic quantum conduction mechanism of charge will allow multiple electrons to occupy the clusters and provide effective electron shielding of the reactants' charges. This is the mechanism to dramatically decrease the coulomb barrier and enable fusion reactions.

This embodiment leverages a combination of factors to achieve the Lawson criterion and favorable triple product. It is the fuel density and plasma that gets to the initial temperature, not high enough for fusion and then the electrical arching through the plasma increases the temperature and time sufficiently to create fusion events.

To explore modern theoretical nuclear simulations for this disclosure, we offer the 2021 comments of Voss Scientific (Albuquerque), known for their decades long work in nuclear fusion for a wide range of government agencies, private companies, and institutions: “We have used fusion simulation models employed within Chicago software simulation code⁸ that include the effects of nuclear reactions, ion thermalization, electron-ion equilibration, and ion-ion large angle scattering. The possibility of a fusion avalanche or enhanced reactivity in p-Li burn has been investigated as a means of increasing the fusion gain via up-scattering of protons by the two fusion alpha particles, which share 7 MeV energy. The up-scattering efficiency is determined by the probability of large-angle Rutherford scattering of protons by alphas along the alpha particle track, whose length (range) is largely governed by the alpha particles' energy loss to plasma electrons and ions. The fusion rate to thermalization rate is key to determining fusion breakeven with this process.” “It is well known that the classical Lawson criterion for p-Li is substantially higher than that for D-T because the fusion cross section is lower and peaks at higher ion energies. Therefore, the p-Li reactivity for Maxwellian ion distributions peaks at significantly higher temperatures than for D-T. Further, if the plasma electrons are in equilibrium with the ions, there are concerns that bremsstrahlung radiation losses may dominate over fusion reactions across the parameter space, making net energy gain impossible. Electron degeneracy in a dense mixture or lattice has been proposed as a method for increasing fusion probabilities at lower temperature. This has the effect of shielding the nuclear Coulomb potentials in a mixture such as lithium ammonia and enhancing fusion cross sections at lower energy. This degeneracy coupled with large up-scattering efficiency lowers the effective Lawson criteria and make cavitation fusion a viable fusion reactor.”

In other approaches, the stability of magnetic confinement is the primary driver of the confinement and fusion burn time. This has been a failure point for other approaches. The inventive LEEF process is cyclical and fusion EMF energy is extracted every cycle via magnetic induction at very high efficiencies, which may exceed 90%, as compared to the approximately 30% seen in “heat” based extraction used in other approaches. The induction field by nature is not a steady state field, nor should it be, if the same issues plaguing other programs are to be overcome. In a pre-ignition state, the inventive LEEF fuel exhibits a coulomb barrier modified by orders of magnitude through a phenomenon known as electron screening.

Reactors according to descriptions herein, of which the drawings are a part, can be scaled across a wide range of physical dimensions, with smaller-sized embodiment being less than a meter across, to more industrially sized embodiments. Since inventive LEEF type fusion reactions do not continuously sustain fusion chain reactions, and the fuel is already ten orders of magnitude denser than traditional deuterium-tritium fuels, massive constructions to provide magnetic or electrostatic confinement, typical of multi-story fusion experimental reactors of the past, are not needed.

Reactors according to these descriptions are cost-effective compared to other approaches. Factors effecting the economic superiority of the inventive LEEF reactors include at least: a LEEF reactor has no minimum critical mass therefore it can be produced in small or large sizes in a factory; it cannot experience a criticality accident; and, it has no special nuclear materials of concern for weapons proliferation, and no high-level radioactive waste. This set of characteristics will dramatically reduce the need for, or costs of, site-specific design modifications, licensing, construction, safety, public relations, export, and operating costs compared to other fission or fusion reactors; even compared to the new fission-based Small Modular Reactors currently being designed to utilize high asset low enriched uranium (HALEU) fuel.

The inventive LEEF technology enables small, modular, and scalable fusion reactors that are safe and inexpensive to manufacture, at the OEM facility rather than on-site. LEEF technology can be used create a global transformation in energy production; delivering constant, distributed energy, anywhere, anytime, without generating greenhouse gases or other hazardous waste products.

Low-cost, abundant, and environmentally clean electricity can be produced by LEEF technology. As the fusion reactions cycle into and out of a chain-reacting state, they create bursts of charged particles that are electromagnetically coupled to the reactor's oscillating magnetic field. This inductive coupling of plasma pressure becomes electromotive force in the magnetic field which is converted directly to electricity. In essence, a LEEF reactor acts as a gain transformer using fusion plasma as its core. This allows the use very efficient power supply regulating techniques to harvest the EMF and subsequently regulate as a switching power supply. Hence, direct conversion into AC or DC output at the voltage, current, and frequency for the desired application, be it 800 V DC for a transportation application, or 35 kilovolts AC in an electrical substation.

The fusion reactions related to this technology have little to no neutrons as byproducts. The reactions create only low-level trace radionuclides with very short lives of no more than a few hours. The table below shows the most promising aneutronic fusion reactions.

TABLE
Aneutronic Fusion Reactions. While all the below reaction are
of interest in these descriptions, the second, third and fourth
reactions are of particular use as non-limiting examples:

| Isotopes | Reaction | |
|---|---|---|
| Deuterium-Lithium-6 | 2D + 6Li → 2 4He _ _ | +22.4 MeV |
| Proton-Lithium-6 | 1p + 6Li → 4He + 3He | +4.0 MeV |
| Helium-3-Lithium-6 | 3He + 6Li → 2 4He + 1p | +16.9 MeV |
| Proton-Lithium-7 | 1p + 7Li → 2 4He _ _ | +17.2 MeV |

The reaction rate of aneutronic fusion is proportional to the nuclear cross section (σ). In a self-sustaining reaction, the rate of reaction is high enough to maintain the temperature required to achieve chain reactions above the ignition barrier. Therefore, the Larsson criteria is briefly satisfied. However, in the inventive cycle, the ignition barrier is briefly met, and then conditions to oscillate above and below it are controlled to achieve cyclic fusion reactions, termed herein as LEEF reactions.

Any given fusion device has a maximum plasma pressure it can sustain. Given this pressure, the largest fusion output is obtained when the temperature (T) is chosen so that the quantity σv/T² is a maximum, where v is the relative velocity. This is also the temperature at which the value of the triple product nTτ required for ignition is a minimum since that required value is inversely proportional to σv/T² (Lawson criterion). A plasma is “ignited” if the fusion reactions produce enough power to maintain the temperature without external heating.

With that said, what is different in inventive LEEF technology is that the fuel is “ignited” momentarily during which atoms chain react, expanding the plasma, imparting energy on the cyclic magnetic confinement and extraction field of the reactor. This creates a diamagnetic electromagnetic force that is converted to electromotive force and is extracted as electric energy. This creates an oscillating plasma of variable density, charge, and temperature.

Traditionally, because of the higher atomic number (and hence higher charge) of the reacting species, and the resulting higher Coulomb barrier, aneutronic reactions are more difficult to achieve than conventional D-T fusion, typically requiring higher temperatures. Inventive LEEF principles include using the power of the magnetic field pumping and fusing of some atoms to build the confinement field back up and create more magnetic pressure and temperature. It is this feedback and amplification that is novel and allows a controlled fizzle fusion to work. Additionally, electron shielding/screening occurs at the anode and cathode that further helps the reactions.

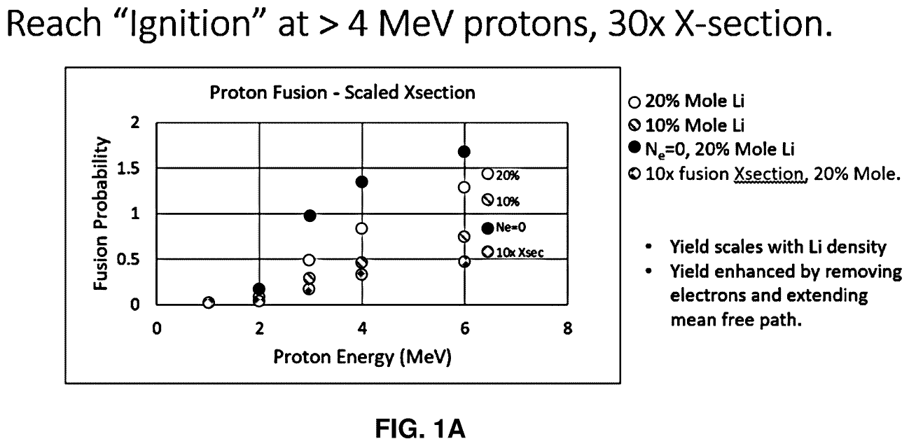

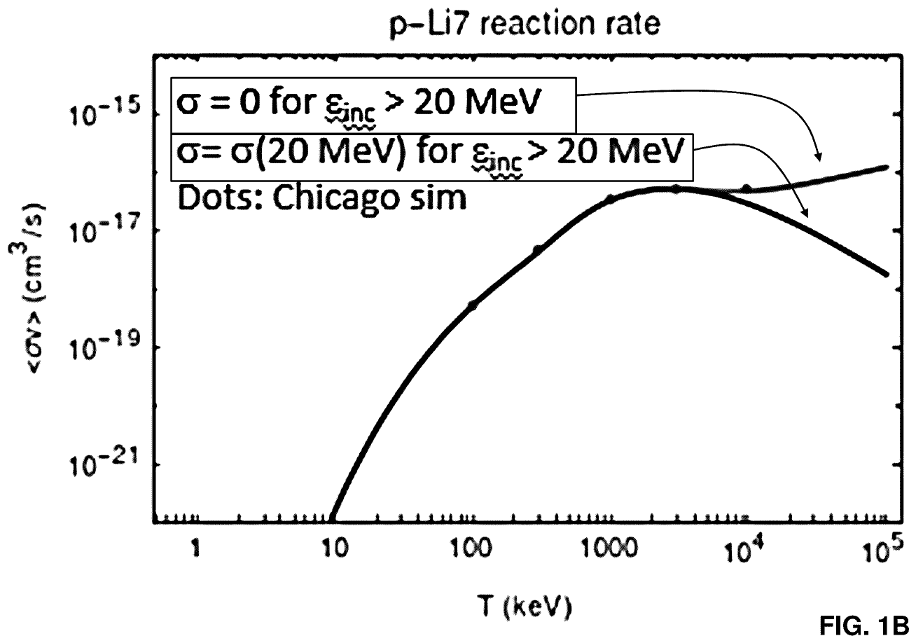

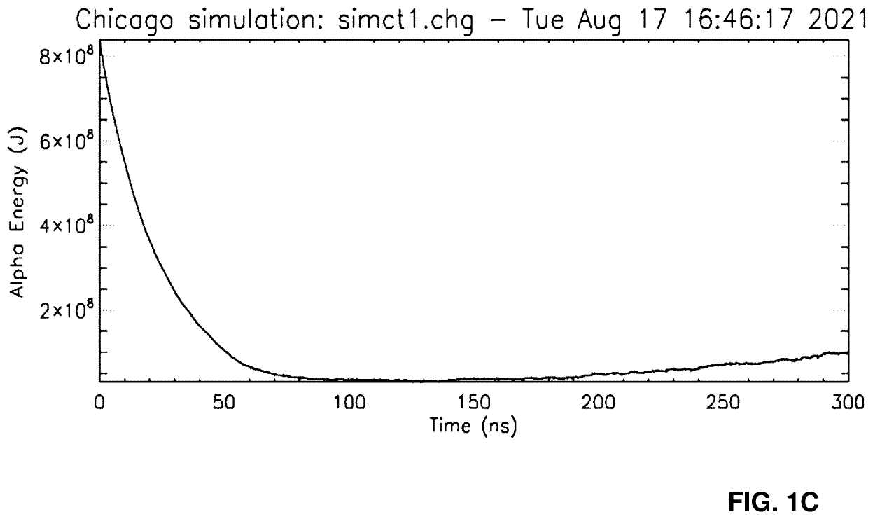

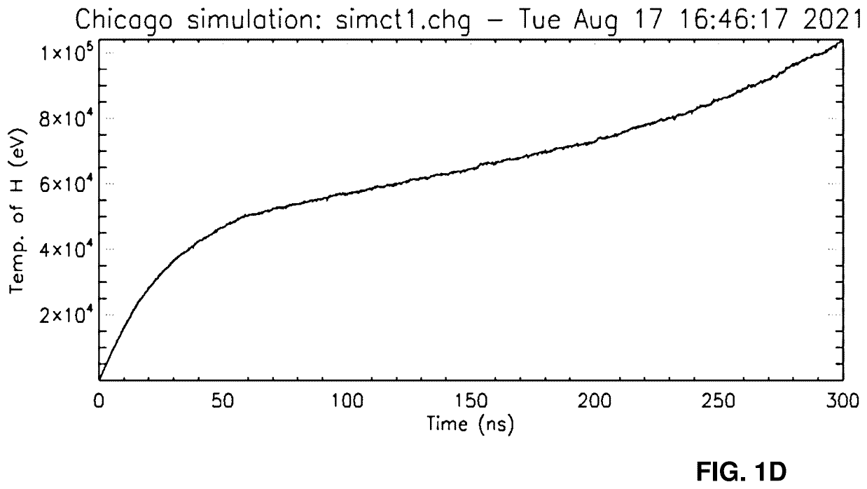

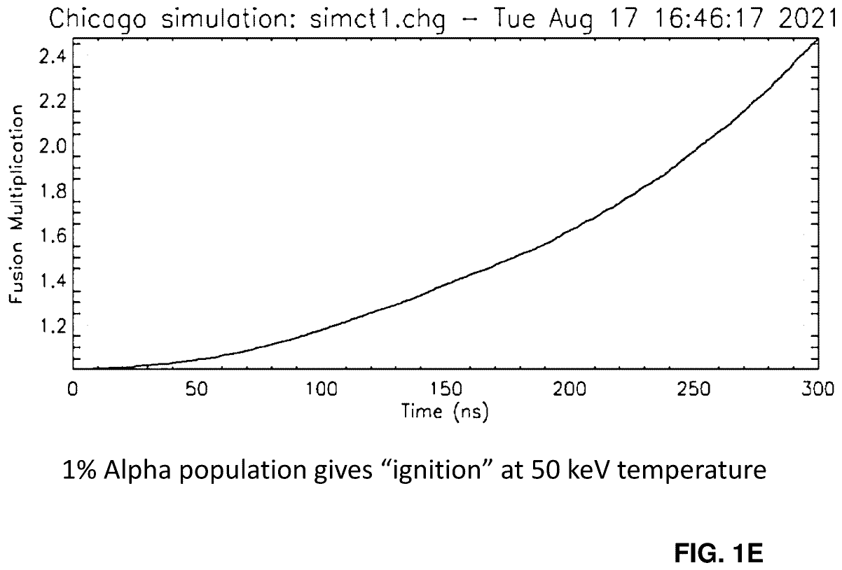

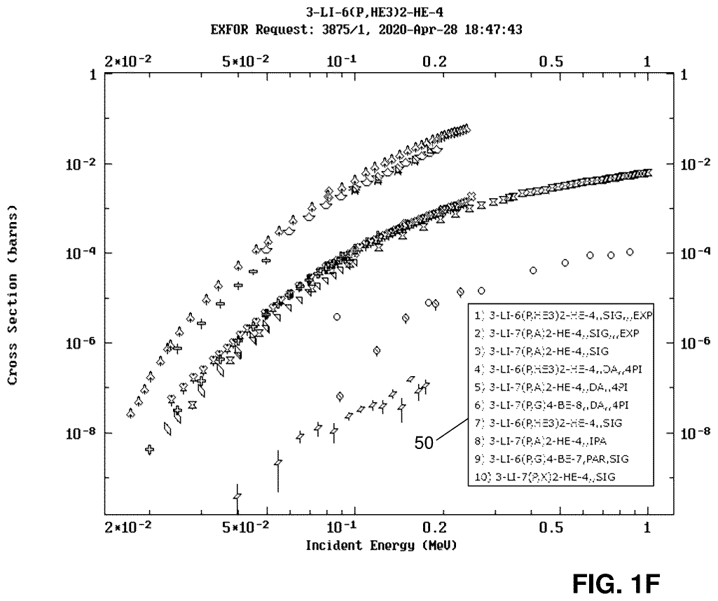

FIG. 1F plots cross section versus incident energy for a number of lithium-based reactions, some of which are listed in the in-graph data window 50. The plots in FIG. 1F show the known science around Li—H fusion provided by the EXFOR library, which is a publicly available online database that contains an extensive compilation of experimental nuclear reaction data. The plotted cross-sectional data was originally acquired generally from linear accelerator experiments. The chart, displaying historical data generated by experiments over years, indicates lithium based fusion reactions and shows how low ignition energies can go in triggering fusion.

Ignition energies in FIG. 1F range from 2 keV up to about 1 MeV. Thus, the data confirms that the inventive developments in reactions according to these descriptions are attainable in that an ignition energy as described herein in some embodiments is much higher than 25 keV. For example, the provided ignition energy can be on the order of 5 MeV, using alpha particles for ignition.

For example, in FIG. 1A, simulation data indicates >4 MeV protons reaches ignition.

In several embodiments, a small portable, yet scalable fusion reactor for generating electricity is disclosed whose cyclical reaction (LEEF) exceeds the Lawson criterion. The fuel is intermittently ignited in a cyclical process, it bursts and fizzles allowing the apparatus to magnetically extract energy through a magnetic plasma pressure carrier increasing potential EMF stored in the coils. This aneutronic fusion reactor consists of a plasma confinement chamber and apparatus in which the lithium-proton fuel is vaporized with a high voltage spark. The plasma arc occurring between mildly (alpha) radioactive electrodes allows for energy extraction via diamagnetic coupling. The chamber confinement apparatus includes an array of electrical coils around the plasma arc which are used for both exciting and extracting energy from the plasma. These coils act as an inductor/electromagnet to capture the electromotive force of the diamagnetic plasma which creates magnetic pressure and subsequent stored EMF. An electrical buck-boost circuit is used to power the magnetic confinement of the plasma and extract electricity through EMF harvesting. Other apparatus embodiments are possible with spherical, toroidal, and twisted geometries. The fuel is a mixture of lithium and ammonia creating solvated lithium with solvated electrons.

A mixture of inert gases, for example, Argon and Neon, and a lithium and ammonia fuel partially fill the containment chamber, or is titrated in, and then is subsequently vaporized with a high voltage spark or other suitable vaporization approach. Then the gaseous fuel is electrically ignited and magnetically contained creating a plasma arc between the electrodes.

Unlike chemical propulsion, there is no combustion of fuel, only the transmutation or creation of helium via the fusion reactions that have few neutrons in their branches and are largely aneutronic. The nuclear fuel is vaporized and, along with low-level alpha radiation and the ionized gases, form a hot plasma between electrodes where a miniscule about of nuclear fusion takes place. The LEEF reaction cycle then harvests energy released (E=mc²) through the EMF of the collapsing magnetic field. In harvesting the EMF from the collapsing confinement field, this allows the reactions to subside out of chain reaction sustainability. The LEEF modified buck-boost electronic power circuitry controls the rate of cyclical process of excitation of fusion reactions and subsequently extraction of energy directly as usable electricity. The LEEF cycle continues in a controllable fashion to create a fusion generator of sorts; more specifically, a fizzle generator capturing EMF generated from fusion reactions.

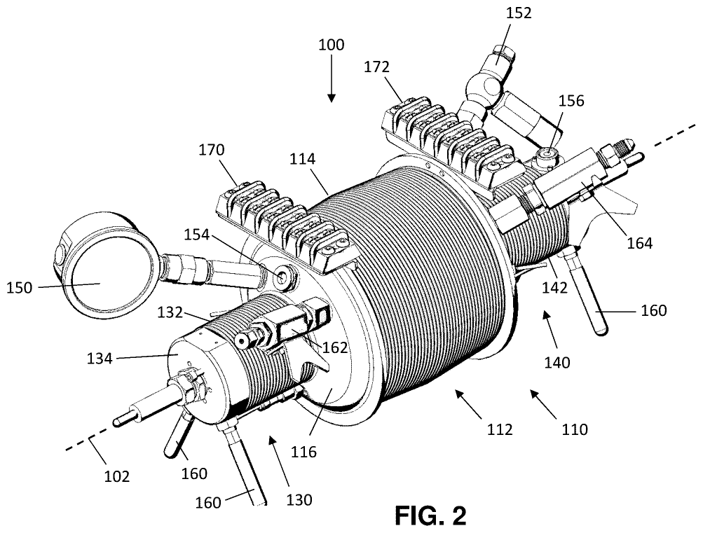

FIG. 2 is a perspective view of the exterior of a device 100, according to at least one embodiment described herein, useful at least as a LEEF reactor, or an aneutronic fusion reactor. The device 100 includes a vessel housing 110, having a central chamber 112, which is shaped as a barrel or as a tapered or bulging cylinder around a central longitudinal axis 102. The central chamber is circumferentially surrounded by a main magnetic confinement coil assembly 114, in an approximate tapered solenoid arrangement, providing circumferential containment of a triggered plasma and stray hot ionized particle species within the device. The vessel housing 110 includes cylindrical chamber extensions 130 and 140, which extend in opposite directions from the central chamber 112 along the central symmetry longitudinal axis 102. A respective magnetic mirror coil 132 and 142 circumferentially surrounds each chamber extension 130 and 140, providing longitudinal containment of a triggered plasma and stray hot ionized particle species within the device. Respective electrical current passed through each coil produces a respective magnetic field.

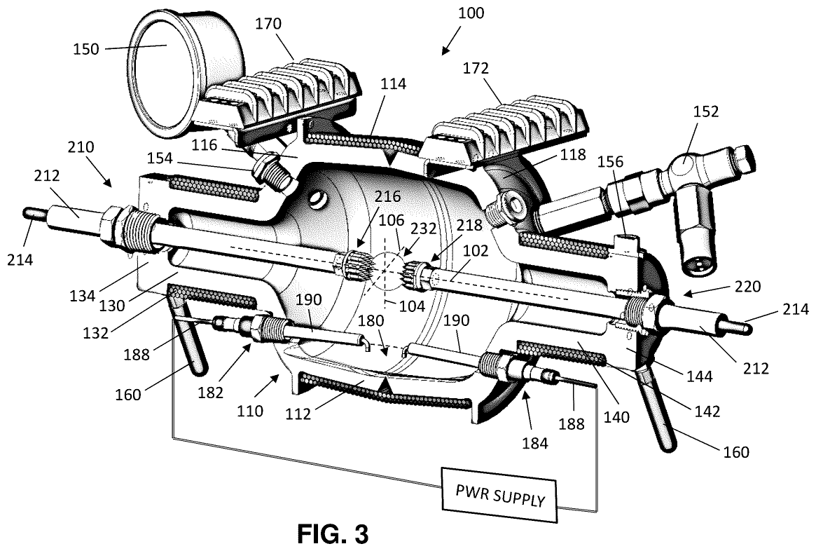

FIG. 2 can be viewed and considered along with FIG. 3, which is a cross-sectional view of the device from another perspective. The vessel housing walls forward of a longitudinally extending vertical center plane, defined as that in which the longitudinal axis 102 and vertical axis 104 lie, are transparent in FIG. 2 to permit illustration of the interior of the vessel housing and placement of the instruments within. As evident in both FIGS. 2 and 3, the central chamber 112 tapers, diminishing slightly in diameter from a center point of the vessel housing to end walls, referenced as a first end wall 116 and a second end wall 118, that connect the longitudinal outer ends of the central chamber 112 to the respective longitudinal inner ends of the cylindrical chamber extensions 130 and 140. Thus, the central chamber 112 bulges circumferentially at its longitudinal center, defined around the intersection of the mutually perpendicular horizontal longitudinal axis 102, vertical axis 104, and horizontal transverse axis 106.

The end walls 116 and 118 are illustrated as tapered or frustoconical, diminishing in diameter with respect to the longitudinal axis 102, from the longitudinal outer ends of the central chamber 112 to the respective longitudinal inner ends of the cylindrical chamber extensions 130 and 140. Thus, the central chamber bulges longitudinally at its longitudinal ends defined by the end walls 116 and 118. The central chamber 112 can be cylindrical with the end walls 116 and 118 being annular in other embodiments. The arcuate form of the central chamber bulging circumferentially and longitudinally is advantageous over exactly circularly cylindrical embodiments toward pressure security. The illustrated embodiment of the reactor device 100 is designed to withstand thousands of pounds per square inch.

The diametric tapering of the central chamber 112 toward the chamber extension 130 and 140 also provides a densifying of the magnetic field provided by the main confinement coil assembly 114 at the longitudinal ends of the central chamber. This provides at least a slight mirroring effect to assist the mirror coils 132 and 142 for longitudinal containment of stray ionized particle species.

Outer longitudinal ends of the first and second chamber extensions 130 and 140 are capped to complete the vessel housing as a sealed enclosure that withstands pressure. The caps, referenced respectively as the first cap 134 and second cap 144, define longitudinal ends of the vessel housing 110, including the interior of the central chamber 112 and the interiors of the chamber extensions 130 and 140.

The interior of the vessel housing 110, particularly the interior of the central chamber 112, is fluidly and electrically accessible via several ports. A pressure gauge 150 or other pressure measuring device is mounted to the first end wall 116 to access pressure conditions in the central chamber 112 to ensure both adequate pressure and guard against explosive pressure. A fast acting pressure relief valve 152 is mounted to the second end wall 118 to ensure safety in case of a sudden fusion chain reaction exceeding pressure vessel design.

An observation port 154 for both visual inspection by eye and other light-based inspections (IR sensor for example) of the interior of the vessel housing 110, particularly the interior of the central chamber 112, is provided at the first end wall 116. A bubble level device 156 is mounted or proximate or at the second end cap 144. This permits establishing or confirming the intended leveling of the device by use of adjustable leveling legs 160, two of which are mounted along the lower sides of the vessel housing proximate or at each end cap 134 and 144.

A fuel injection port and valve assembly 162 (FIG. 2) is shown mounted on the first end wall 116, extending from the central chamber 112 radially and longitudinally. A vacuum port and valve 164 for cleaning and purging the vessel housing before fueling or re-fueling is shown mounted on the second end wall 118, extending from the central chamber 112 radially and longitudinally as well.

First and second electrical coil winding termination blocks, referenced as a first termination block 170 and a second termination block 172, are mounted respectively at the longitudinal ends of the central chamber 110, along the exterior thereof and overhanging the respective first and second end walls 116 and 118. The termination blocks 170 and 172 allow for both serial and parallel connections to tune both impedance and resistance of the main confinement coil assembly 114. The mirror coils can also be tuned at the blocks, or they could be tuned anywhere that is convenient for mechanical and electrical design.

Coil windings of the main confinement coil assembly 114 are of different lengths and resistance circuits are used to tune the magnetic field. An additional electrically separate coil is used for extracting back electromotive force generated from fusion reactions impinging on the magnetic field.

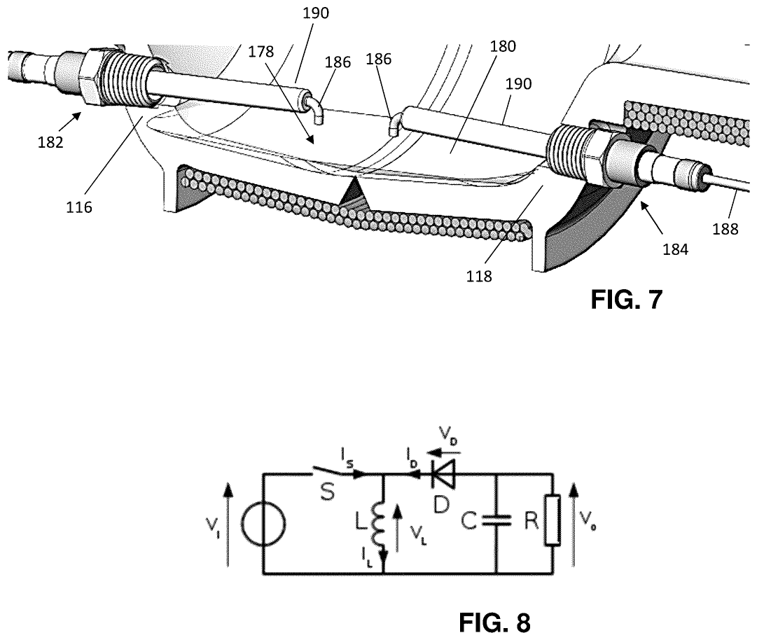

A puddle of solvated lithium fuel 180 (FIG. 3) is accumulated in a reservoir area 178 in the bottom of the central chamber 112 before arc vaporization. High-voltage fuel igniters are referenced as the first igniter 182 and second igniter 184, each having a vessel-interior electrode terminus 186 (see also FIG. 7, which is enlarged) that contacts the liquefied fuel and a vessel-exterior contact 188 via which an external power supply provides electrical voltage and current to the interior electrodes to heat and vaporize the fuel. For each igniter, an insulating sleeve 190, for example made of ceramic or other heat-durable electrically insulating material, surrounds an interior electrically conducting rod that extends from the exterior contact 188 to the electrode terminus 186. The sleeve 190 extends through a seal assembly that mounts the respective fuel igniter to its respective side of the central chamber 112 through the respective end wall 116 or 118. The electrically insulating sleeve 190 assures that the interior rod is electrically insulated from the walls of vessel housing 110.

In use, the exterior contacts 188 are electrified with high voltage, which is applied thereby to the respective electrode terminus 186 cause arcing across and into the highly conductive liquefied fuel 180, consequently vaporizing the fuel into the chamber 112. Two electrodes are used instead of one, so that the vessel housing portions are essentially equipotential, and may be firmly electrically grounded in use.

An opposing pair of primary arcing electrode assemblies are referenced as a first arc assembly 210 and a second arc assembly 220. Like the first and second igniters 182 and 184, the constructions of the first and second arc assemblies 210 and 220 are symmetric across a transversely extending vertical center plane, defined as that in which the transverse axis 106 and vertical axis 104 lie (FIG. 3). Thus, a description generic to the two arc assemblies is sufficient. Each includes a respective insulating sleeve 212, for example made of ceramic or other heat-durable electrically insulating material, that surrounds an interior electrically conducting rod. The sleeve 212 extends through a seal assembly that mounts the respective arch assembly (210, 220) to its respective side of the vessel housing 110 through the respective cap (134, 144). The electrically insulating sleeve 212 assures that the interior rod is electrically insulated from the vessel housing walls. At a vessel-exterior end of the sleeve, a contact 214 extends via which an external power supply provides electrical voltage and current to a vessel-interior electrode array. From the cap (134, 144) to the electrode array, the arc assembly (210, 220) extends longitudinally into the vessel housing 110, and is cantilever supported within the vessel by the respective cap (134, 144) by which the arc assembly (210, 220) is mounted to the vessel. Thus the electrode array defines the cantilevered terminal end of the respective arc assembly.

The electrode arrays of the first and second arch assemblies are separately referenced in the drawings respectively as the first electrode array 216 and second electrode array 218. Each of the arrays has a base plate 222 (FIG. 5, 6) from which electrode rods 224 extend longitudinally. The electrode rods 224 extend longitudinally inward within the vessel housing 110, such that the electrode array 216 of the first arc assembly 210 extends its electrode rods 224 toward the electrode rods 224 of the electrode array 218 of the second arc assembly 220. For brevity in these descriptions, the electrode rods 224 of the first electrode array 216 are termed as first electrode rods 224, and the electrode rods 224 of the second electrode array 218 are termed as second electrode rods 224, which need not be separately numbered in the drawings due to their similarities.

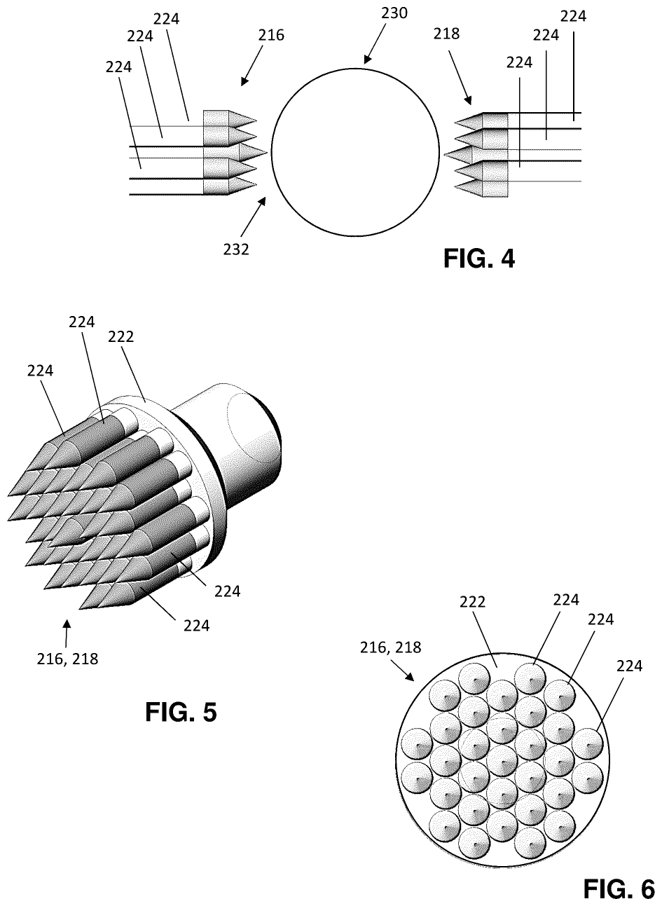

In use as represented in FIGS. 3-4, a plasma nuclear reaction zone, referenced as zone 230 in FIG. 4, is defined between the inward directed terminal tips 226 of the first electrode rods 224 and the inward directed terminal tips 226 of the second electrode rods 224. The terminal tips 226 are inward directed with regard to the transversely extending vertical center plane and into the gap 232 between the first and second electrode arrays 216 and 218. The terminal tips 226 are tapered as sharp cones for increased field gradients to promote ionization of gaseous fuel and other gaseous reactant species especially in the gap 232.

The center electrode rod in each of the first electrode array 216 and second electrode array 218 is longer than the others in the respective array for a centering effect of gas ionization and plasma triggering, where distance between the arrays is defined as a minimum between the aligned tips of the center electrode rods. The electrode rods 224 in each array can vary in number. A matched number in the two arrays, and general symmetry of the arrays across the transversely extending vertical center plane, effect the centering effect as well. There can be just a few, dozens, and even hundreds of electrode rods 224 in each of the two arrays. The number and placement density of the rods 224 is driven by the alpha particle requirements for a particular range of fusion reactions.

The electrode rods 224 may be constructed, for example, of tungsten to assure durability from heat and electrical arcing. The electrode arrays 216 and 218 act as anode and cathode as voltage is applied across the gap 232. Their roles may be assigned or alternate. That is, in some embodiments and uses the first electrode array 216 may serve as the cathode while the second electrode array 218 serves as the anode; while they serve as vice versa in other embodiments; and yet in other embodiments they may alternate in real time in use.

To promote the triggering of plasma and of fusion events, especially within the gap and area around the electrode arrays, the electrode rods 224, at least at the terminal tips in the embodiment of FIGS. 4-6, are coated with at least one radiation source, referring to at least one nuclear species that decays by radioactive decay thereby causing ionizing radiation to enter areas around the rods, for example the gap area. The emitted ionizing radiation may be a direct emission of a parent nuclear species that decays, and may be the emissions of decay sequence daughter species in a decay chain.

In particular, thoriated welding rod spikes may be used as the first and second electrode rods. For example, 4% thoriated tungsten welding rod spikes may be used. Thoriated welding rods are commercially available, and thus their preparation need not be further described here. The thorium in this embodiment emits alpha particles, which assist to trigger the plasma by creating gas ionization along the path of the scattering alphas, thereby opening paths of conduction in the gap 232, where further ionization caused by breakdown occurs, and a plasma develops.

The alphas also trigger fusion events to seed a controlled fusion chain-reaction environment in the plasma. This can be understood, for example, in view of the reaction ignition energies in FIG. 1F, which range from 2 keV up to about 1 MeV, whereas the energies of alphas emitted by the thoriated welding rods can be on the order of 5 MeV and are thus energetically sufficient, indeed abundantly so, to provided ignition energy to trigger fusion events.

Although the radioactive species doped electrode rods 224 are described in some examples here as thoriated, other radioactive nuclear species (radioisotopes) can be used in lieu of or, in addition to, thorium. For example, other alpha emitters, such as radon, can be used. Gamma emitters can also be used, although particle emitters such as alpha emitters are likely more effective for triggering ionizing of any given host gas, and are further effective for sparking fusion reactions from which chain reaction continue.

To regulate the magnetic field and extract energy from the reactions in the device 100, an electrical buck-boost power supply circuit 240 is used, for example as shown in FIG. 8. The circuit 240 powers the magnetic confinement of the plasma and extracts electrical power through EMF harvesting. The coils may share a single magnetic core. The coils drop the output ripple, and add efficiency. The circuit 240 is used as a switching power supply and for coupling of the EMF to transfer energy for use. Using burning plasma as a core of the transformer, energy can be harvested. As energy is extracted, the reaction continues until density falls off. The inventive cycle of fusion ignition, chain reaction propagation in the plasma, and energy extraction in which the plasma cools, is thus inherently safe and self-limiting.

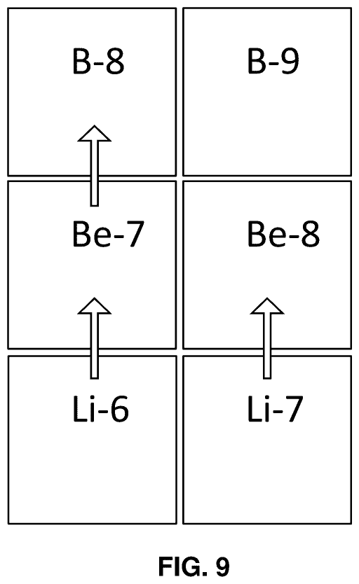

The cycle begins with the vaporization of the fuel 180. At the electrode rods 224, alpha particle radiation, or other ionizing radiation from the doped rods, flies through the vaporized fuel and scatters hydrogen and lithium nuclei, causing scattering and fusion events, creating beryllium in at least some exemplary reaction processes. FIG. 9 is a section of the known nuclide chart provided to illustrate exemplary reactions chains by which the device 100 in the illustrated embodiment and other embodiments within the scope of these descriptions, produces useful energy. A first reaction in some implementations is a fusion event briefly yielding a decay of protons or alphas. For example, where natural lithium is used as a fuel, both lithium-6 (⁶Li, Li-6) and lithium-7 (⁷Li, Li-7) are available in the liquefied fuel proximate the electrode rods. Fusion events produce respectively Be-7 and Be-8 from these species, leading through Be-7 and Be-8 to Boron. The usable energy produced by the reaction of Li-7 to Be-8 is a primary energy source. In the Li-6 to Be-7 sequence, Be-7 has a half-life of 10-5 seconds, decaying to B-8. In the Li-7 to Be-8 sequence, Be-8 has a half-life of 10-15 seconds, decaying to B-9.

The fuel source and process cycle herein are novel: by utilizing such fuel sources; by ignition by plasma and by ignition of fusion events using alpha emitter decays as triggering; by harvesting plasma thermal energy through a transformer routine for direct electrical power production via magnetic coupling; by controlling, containing, and cooling the plasma through the electrical power extraction; and by assuring vessel safety by this cyclic energetic quenching and extraction.

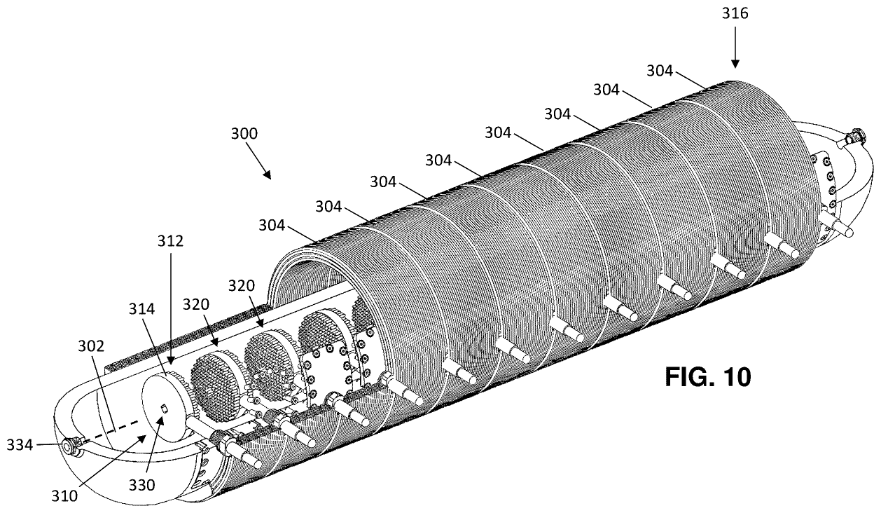

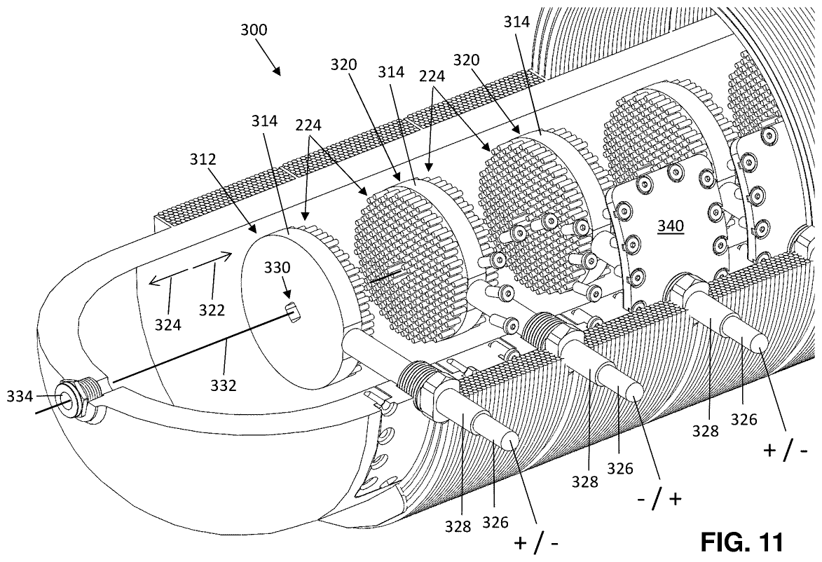

FIG. 10 shows a multi-plasma reactor device 300 in which a column 310 of multiple electrode arrays, some of which are bi-directional, are arranged along a longitudinal axis 302. Primary containment coil sections 304 surround the electrode array column. A portion of the device is shown in enlarged view in FIG. 11. In operation, and in many features, the multi-plasma reactor device 300 has similarities in common with the above-described device 100, such that the above descriptions apply in part upon the reactor device 300. A first electrode array 312 in the column 310 has electrode rods 224, which may be understood according to the above-described electrode rods 224, that extend from just one side of a base plate 314 along the longitudinal axis 302 in a first direction 322 toward the interior of the vessel. A last electrode array 316 in the column 310, the approximate location of which is indicated in FIG. 10, is not expressly shown, but is arranged in mirror symmetry relative to the first electrode array 312, having electrode rods that extend also from just one side of a base plate along the longitudinal axis in a second direction 324 toward the interior of the vessel and opposite the first direction 322.

The intervening electrode arrays 320 of the column between the first electrode and second electrode array are bi-directional, each having electrode rods extending longitudinally from both sides of a base plate. Thus, each intervening electrode array 320 has first electrode rods 224 extending in the first longitudinal direction 322 from a first side of the base plate 314 and second electrode rods 224 extending in the second longitudinal direction 324 from the opposite second side of the base plate 314. To promote plasma triggering all along the column and in each gap between each adjacent two base plates 314, the base plates along the column, and the electrode rods extending therefrom, are alternatingly electrified with regard to polarity or electrical potential difference therebetween. This generates electrical fields in opposing directions at opposing sides of any given electrode array and facilitates each gap being a plasma and fusion reaction area. This is represented in FIG. 10 by the alternating (+/−) indicators along the vessel-exterior contacts 326, serving alternatingly as anode and cathode, extending from the vessel-exterior ends of the insulating sleeves 328 in FIG. 10.

The base plate 314 of each electrode array in the reactor device 300 of FIGS. 10-11 has a hole 330 (FIG. 11) for propagation of the triggering laser 332 through the device longitudinally. The holes 330 are aligned along the central longitudinal axis 302 of the device, as represented in FIG. 11 by the line of propagation of the laser beam 332. A dome-shaped or half-spherical longitudinal end cap shown in the foreground in FIGS. 10-11 has a laser ignition port 334 allowing for each nuclear reaction zone to be ignited. Each electrode array can be accessed for replacement or servicing via a respective mechanical plate 340 (FIG. 11) from which the array is laterally supported in “lollipop” cantilever fashion. The removal of the plate 340 exposes an opening allowing for removal and replacement of the respective array, be that the unidirectional first array or last array, or any intervening bidirectional array therebetween.

The base plates 314 are circular, corresponding to the cylindrical symmetry of the vessel wall between the end caps. The base plates 314 extend into the vessel interior from a lateral portion of the cylindrical sidewall. In the at least one implementation, the reactor device 300 has a diameter around the longitudinal axis 302 of approximately seven inches, and had eleven fusion reactions zones (the gaps) between twelve electrode arrays. The reactor device 300 of FIGS. 10-11 is designed as multi-megawatt reactor with the ability to deliver variable deliver power based on how may fusion reaction zones are excited.

The electrode rods 224, including those of the first electrode array 312, and last electrode array 316, and those on both sides of the intervening electrode arrays 320, are doped with emitters of ionizing radiation as described above with reference to the reactor device 100. For example, the electrode rods in FIGS. 10-11 may also be thoriated tungsten rods mounted on a respective base plate 314 around the hole 330. The surrounding magnetic coils both confine the plasma and extract electrical energy. An advantage of this design is the ability to have plasma/nuclear reactions with one set of lollipop arrays, or multiple, thereby varying the power output potential to match the power load requirements at different times of the day or night.

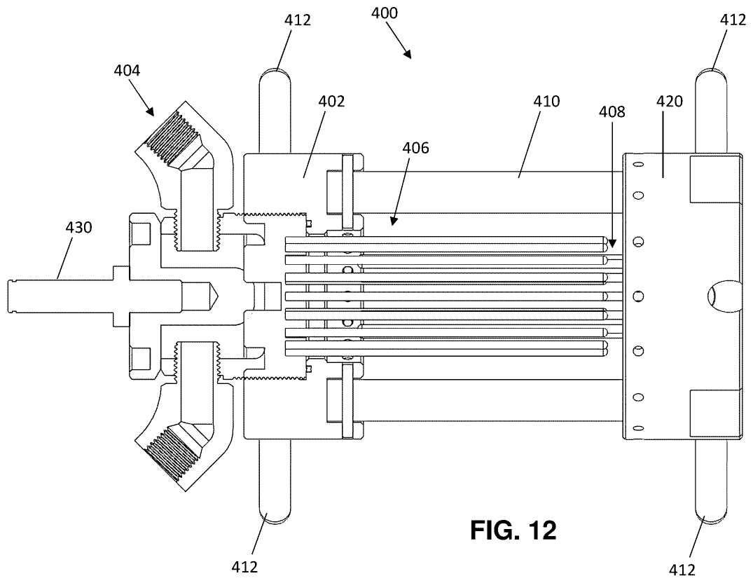

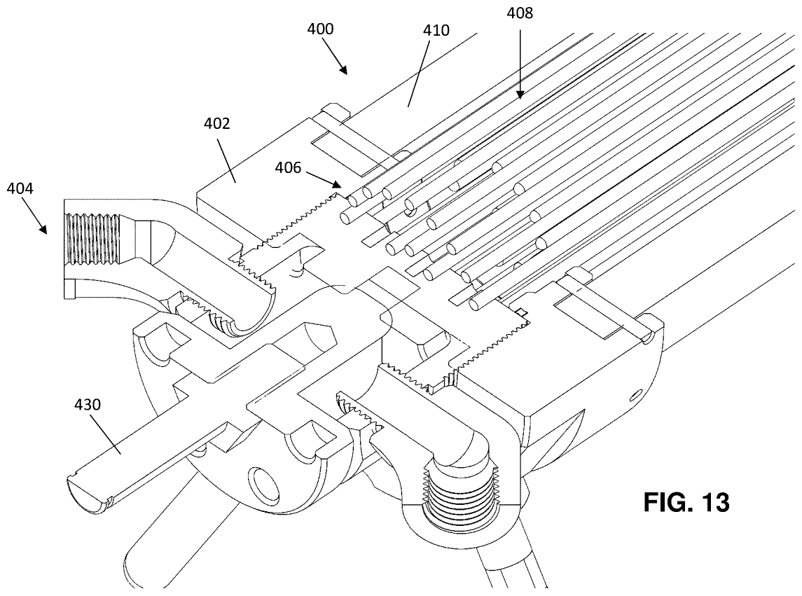

FIGS. 12-13 show a cartridge style reactor device 400 in an embodiment having overlapping anode-cathode throated tungsten alpha emitting rods and an end cap 402 that supports liquid cooling of those rods with, for example, transformer oil.

In operation, and in many features, the reactor device 400 has similarities in common with the above-described device 100, such that the above descriptions apply in part upon the reactor device 400. The reactor device 400 of FIGS. 12-13 has a port 404 for electrically non-conductive transformer cooling oil that extracts heat from the end-cap 402 and the mechanically fixed anode or cathode reactor rods 406 attached to the first end-cap 402. The opposite end cooling channel is not shown. The longitudinally surrounding ceramic tube/cylinder 410 improves magnetic confinement. Adjustable legs 412 permit leveling and bench top or mechanical mounting. A primary electrical connector 430 extends from a first longitudinal end of the reactor device. Variably overlapping movable cathode or anode rods 408 extend longitudinally within the interior between and among the fixed reactor rods 406. The extent of overlap and the intimacy or mutual exposure between the fixed rods 406 and movable rods 408 is defined by the position of the movable rods 408. The power production of the reactor device 400 is thus controlled by way of positioning the movable rods 408.

Stainless steel end caps 402 and 420 hold the ceramic tube 410 and allow for replacement and interchange of reactor rods. The fixed reactor rods 406 extend longitudinally into the reaction chamber from a first end of the reactor device from the first end cap 402. The movable reactor rods 408 extend oppositely into the reaction chamber from the second end of the reactor device from the second end cap 420.

In another embodiment, the reactor device utilizes a fuel cartridge containing replacement electrodes and fuel is sealed in an easily handled package. The pooled fuel mixture is vaporized due to its highly conductive nature with a high voltage electric spark to form a gaseous soup within the chamber. This vaporization is accomplished via separate low current high and voltage electrically isolated electrodes. Alternatively, the vaporization can be done via laser, ultrasonically, or spark and arc. Next, the fuel is ignited via the magnetic pressure confinement field, increasing both plasma temperature/pressure and the electrical current sent through the main electrodes via an electronic circuit. The main electrodes described above as electrode arrays serve as arc heads that are radioactive, for example with alpha emission from thoriated welding rods or other suitable materials. Alternatively, radiation sources or capsules can be used to create alpha, beta, gamma, or neutron radiation.

Particular embodiments and features have been described with reference to the drawings. It is to be understood that these descriptions are not limited to any single embodiment or any particular set of features, and that similar embodiments and features may arise, or modifications and additions may be made without departing from the scope of these descriptions and the spirit of the appended claims.

### REFERENCES

1—https://inis.iaea.org/search/search.aspx?orig_q=RN:8279931
2—W. Lochte-Holtgreven, Research on Nuclear Reaction in Exploding Wires, Z. Naturforsch. 42a, 5380542 (1987)
3—W. Lochte-Holtgreven, Nuclear Fusion of Very Dense Plasmas Obtained From Electrically Exploded Liquid Threads, Atomkernenergie, V. 28, 1976, p. 150-
4—https://iopscience.iop.org/article/10.1088/1742-6596/337/1/012062
5—A group of 1989 papers on electron screening and fusion rate enhancement|IDA (project-ida.org)
6—https://doi.org/10.1007/BF02459026
7—https://en.wikipedia.org/wiki/Solvated_electron
8—http://www.vosssci.com/products/chicago/chicago.html

What is claimed is:

1. A method of prompting fusion and harvesting energy therefrom, the method comprising:
providing lithium and ammonia;
creating, using the lithium and ammonia, a solvated electron fuel source;
providing an alpha particle or proton source in a reaction site in a chamber where the fuel source is present, thereby prompting fusion events in the reaction site; and
harvesting energy from the fusion events.

2. The method of claim 1, wherein the alpha or proton source comprises at least one of: thorium, americium metals, powders mixed into the fuel, thorium hydride directly into the fuel.

3. The method of claim 1, wherein the lithium comprises at least one of Li-7, Li-6, and a combination thereof.

4. The method of claim 1, wherein the fuel source is weakly saturated with Lithium or fully saturated at 22% mole fraction.

5. The method of claim 1, wherein the method is cyclical in nature not continuous.

6. The method of claim 1, wherein the chamber comprises magnetic confinement.

7. The method of claim 1, wherein and interior of the chamber has a pressure in the range of 10 bar to 1000 bar.

8. The method of claim 1, wherein the chamber is surrounded by electrically conductive coils that allow for induced currents and voltage to be harvested as electrical or device gain.
